(19) United States
(12) Patent Application Publication
(10) Pub. No.: US 2006/0247826 A1
(43) Pub. Date: Nov. 2, 2006

(54) HVAC diagnostic system and method

(76) Inventors: Kenneth Ray Green, Denton, TX (US); Kevin Mark Klughart, Denton, TX (US)

Correspondence Address: KEVIN MARK KLUGHART, 2516 LILLIAN MILLER PARKWAY, SUITE 115, DENTON, TX, 76210-7205, US

(21) Appl. No.: 11/241,652

(22) Filed: Sep. 30, 2005

Related U.S. Application Data
(60) Provisional application No. 60/676,876, filed on May 2, 2005.

(51) Int. Cl. G05D 23/00

(52) U.S. Cl. 700/276

(57) ABSTRACT

A HVAC diagnostic system and method is disclosed which permits bypassing the normal operation of a thermostat by HVAC service personnel, typically permitting the HVAC service personnel control over thermostat functionality while servicing the condenser coils and/or compressor located external to customer building. The present invention is useful in situations where HVAC service calls must be scheduled at customer premises such as homes, apartments, etc., during normal hours where the occupants are not typically available to permit access to the thermostat within the building structure. By permitting override of the customer thermostat at the compressor/condenser unit, the system permits servicing of this unit without customer assistance. As such, HVAC service can be completed on a more regular schedule, saving substantial energy and providing improved customer environmental comfort.

### CROSS REFERENCE TO RELATED APPLICATIONS

Applicants claim benefit pursuant to 35 U.S.C. §119 and hereby incorporates by reference Provisional Patent Application for “HVAC DIAGNOSTIC SYSTEM AND METHOD”, Ser. No. 60/676,876, docket KRG-2005-001, filed May 2, 2005, and submitted to the USPTO with Express Mail on May 2, 2005 with tracking number ER618468081US.

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention is related directly to situations in which heating/ventilation/air conditioning (HVAC) systems must be tested and serviced by technicians. These systems typically comprise evaporator coils and other equipment contained within a building structure and condenser coils and associated compressor located external to the building structure. These systems are typically controlled via a thermostat or other temperature sensor located within the building structure. The present invention provides a system and method of testing and servicing these units without need for entry into the building or physical access to the control thermostat. This elimination of building entry as a prerequisite to HVAC servicing permits regular service calls to the HVAC system without the need for intervention by the homeowner or other building structure occupant, resulting in higher system efficiencies and resulting energy savings.

### PRIOR ART AND BACKGROUND OF THE INVENTION

### Overview (0100)

The prior art with respect to the present invention is generally illustrated in FIG. 1 (0100), wherein a house or other building structure (0101) is serviced by a heating/ventilation/air conditioning (HVAC) system comprising a thermostat (0110), evaporator/fan assembly (0120), located within the building structure (0101) and a corresponding condenser/compressor assembly (0130) located external (0102) to the building structure (0101). These systems may incorporate a variety of heating mechanisms, including electric, gas, and fuel oil heat, as well as integration with heat pump systems in some configurations.

### Typical Heat Pump System (0200)

A typical schematic of a heat pump system is illustrated in FIG. 2 (0200). The control interface (0201) to the indoor thermostat generally comprises a wiring harness having standard color codes of R/E/O/W1/Y/W2/W3/C.

### Wiring Color Code Standards (0300)

While the wiring of each individual HVAC system may vary considerably, there does exist a set of widely applicable wiring designations and color code standards as applied to the thermostatic control interface. FIG. 3 (0300) provides a table illustrating typical thermostat wire color codes and the functional description of the associated wire controls. This table is applicable to the Honeywell model CT3611 programmable thermostat, but is equally applicable to both digitally programmable as well as mechanical thermostats.

One skilled in the art will recognize that tables typically illustrated in FIG. 3 (0300) may readily be used in conjunction with the teachings of the present invention to incorporate remote diagnostic features into any existing HVAC system incorporating a wide variety of wiring standards.

### Conventional HVAC System (0400)

A typical schematic of a HVAC system including controls is illustrated in FIG. 4 (0400). The system generally incorporates a thermostat (0401) having HEAT/OFF/COOL switch (0402) and associated AUTO/ON fan control (0403). Contactors or relays control the compressor (CC), fan (FC) and gas/fuel/electric heat (GC)/(SEQ) respectively in response to the temperature/fan controls of the thermostat. Note that gas/fuel based heating systems may incorporate a sequencer (SEQ) in conjunction with the GC contactor/relay to properly sequence operation of these systems. Additional low/high pressure sensors may also be incorporated to provide operational protection for the compressor due to out-of-range refrigerant conditions.

### Problems Associated with the Prior Art

A serious drawback with the existing prior art as illustrated in FIG. 4 (0400) is that all controls for the HVAC system are located in the thermostat (0401), which is resident inside the building structure. For a typical household, this requires that the homeowner be at home when the service technician is servicing the HVAC system so that the HVAC technician has access to the thermostat.

During a typical service call, the service technician will activate the air conditioner by forcing the thermostat to trigger the compressor unit. Once the compressor is activated, the service technician will inspect the operation of the air conditioning compressor as well as check refrigerant levels and their associated operating pressures. Other operations may also be performed, as in verifying the operation of a heat pump and A/C systems or by activating the heating unit (furnace) associated with the HVAC system.

In any of these scenarios, access to the thermostat is required to permit the HVAC service technician to force operation of the compressor located external to the building structure. The requirement of access to the thermostat presents a significant scheduling problem with most homeowners, who must leave work to be present during the service call. Given that a given service technician may be delayed due to traffic or unforeseen problems at a given customer site, the accurate simultaneous scheduling of both the customer and the service technician is a recurring and unresolved problem in the HVAC service industry.

As a result of the scheduling problems associated with servicing the prior art, many homeowners do not regularly schedule preventative maintenance for their home HVAC systems. As a result, these systems often operate at less than peak efficiency. This condition often results in significantly lower energy efficiency for the HVAC, and as a result the prior art consumes more energy than an optimally maintained configuration.

### OBJECTIVES OF THE INVENTION

Accordingly, the objectives of the present invention are (among others) to circumvent the deficiencies in the prior art and affect the following objectives:
(1) To provide a system and method permitting remote control of a HVAC system external to a given building structure.
(2) To permit the override of a given HVAC thermostat from a point proximal to the condenser/compressor located external to the building structure.
(3) To eliminate the need for customer presence at the building structure during normal HVAC service calls.
(4) To eliminate the need for access to the customer building to perform normal HVAC service operations.
(5) To permit secure remote control of a given thermostat as well as monitoring of HVAC system status via the use of a wireless communications link.
(6) To permit a significant reduction in energy consumption by residential HVAC systems by permitting more frequent and unattended maintenance of these systems.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention as generally illustrated in FIG. 5. The prior art system diagram of FIG. 4. (0400) is augmented by the teachings of the present invention in FIG. 5 (0500) to incorporate a sail switch (0511), light emitting diode (0512), current limiting resistor (0513), compressor override switch (0514), and heating override switch (0515). The sail switch (0511) permits detection of HVAC cooling fan operation within the building structure and indicates such by illuminating the LED (0512) through the optional current limiting resistor (0513). Note that the LED (0512), current limiting resistor (0513), compressor override switch (0514), and heating override switch (0515) are all located OUTSIDE the building structure, preferably proximal to the enclosure housing the compressor and compressor fan. This location permits the service technician to override the thermostat inside the building structure from the HVAC compressor unit without the need for physical access to the building structure.

By permitting override of the HVAC thermostat by HVAC service personnel external to the building structure, the present invention permits maintenance functions to be performed without the need for on-site presence of the customer. This configuration permits more frequent HVAC service calls and results in an overall improvement in system efficiency and uptime.

### BRIEF DESCRIPTION OF THE DRAWINGS

For a fuller understanding of the advantages provided by the invention, reference should be made to the following detailed description together with the accompanying drawings wherein:

FIG. 1 illustrates a conventional prior art HVAC system block diagram;

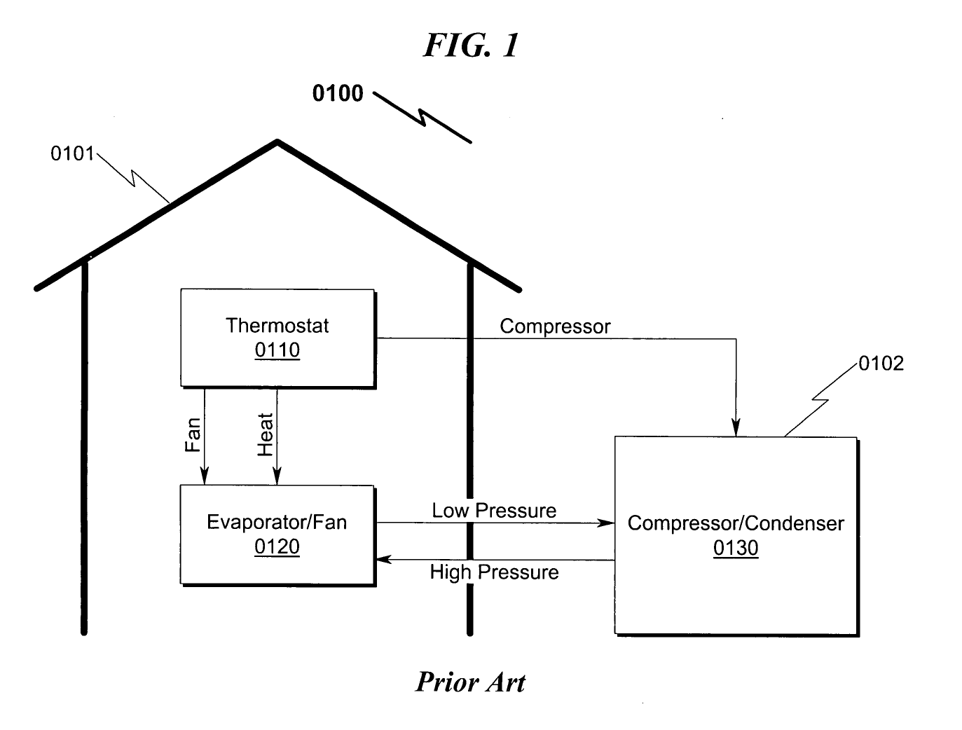

FIG. 2 illustrates a typical prior art HVAC system schematic incorporating a heat pump;

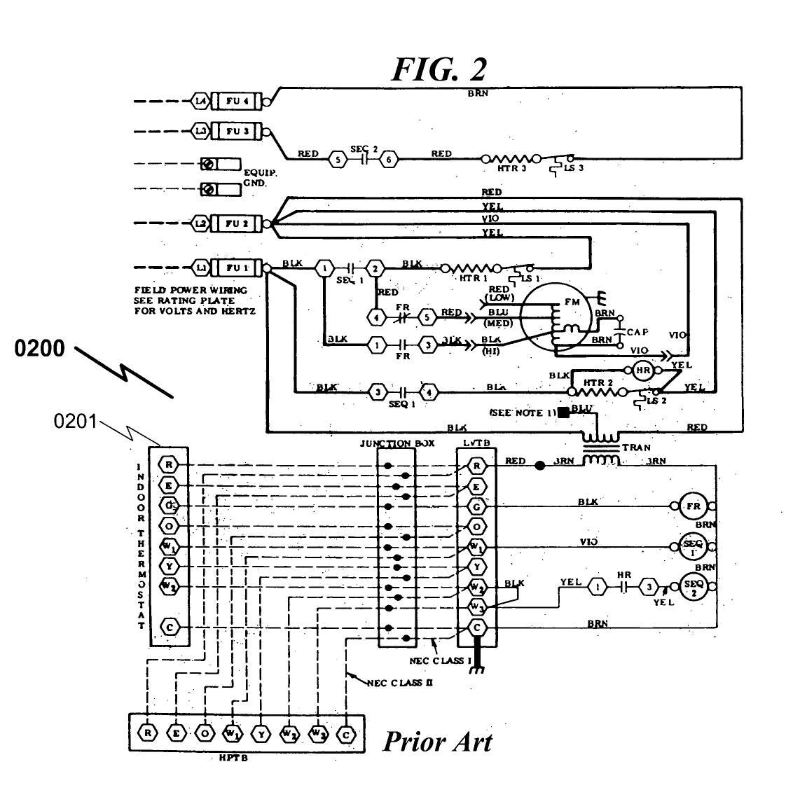

FIG. 3 illustrates a color code table associated with prior art thermostat connections;

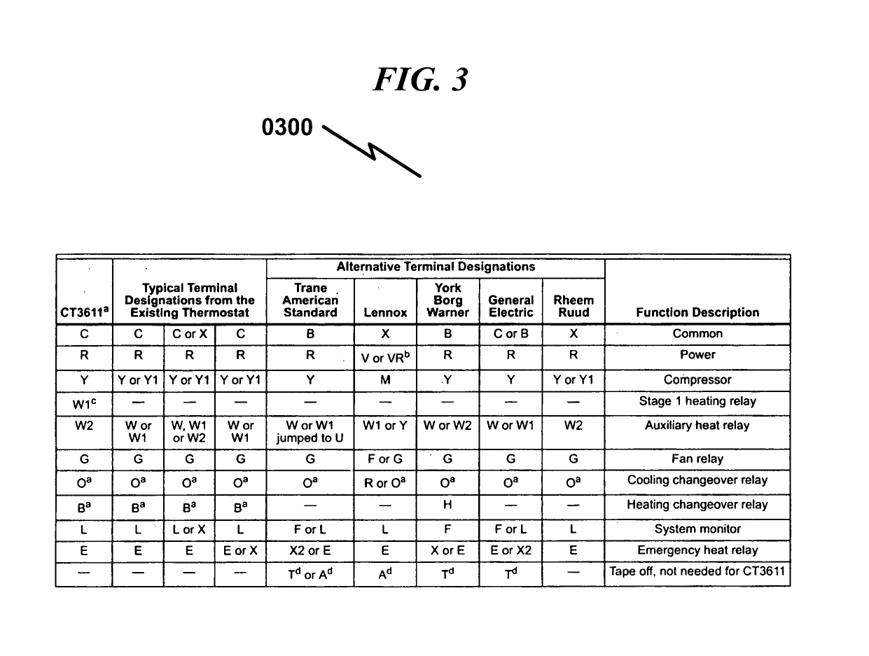

FIG. 4 illustrates a simplified prior art HVAC system schematic;

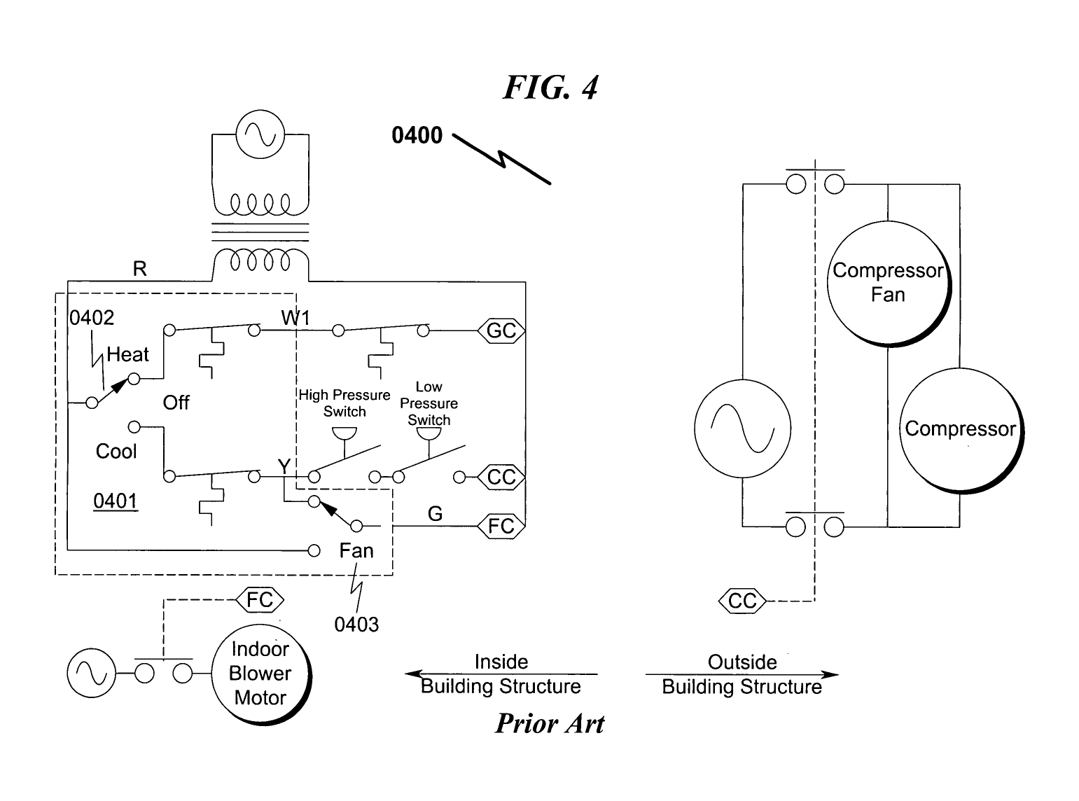

FIG. 5 illustrates a preferred exemplary embodiment of the present invention as applied to a remote HVAC diagnostic console located on the compressor/condenser system unit;

FIG. 6 illustrates a preferred exemplary embodiment of the present invention incorporating a wireless communication link between a remote handheld transceiver and a remote control/monitor unit;

FIG. 7 illustrates a preferred exemplary embodiment of the present invention incorporating a wireless thermostat which communicates with a remote control/monitor unit and a remote handheld transceiver.

FIG. 8 illustrates a preferred exemplary HVAC diagnostic method embodiment of the present invention when used to service HVAC systems using remote override controls.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a HVAC DIAGNOSTIC SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Exemplary System Embodiment (0500)

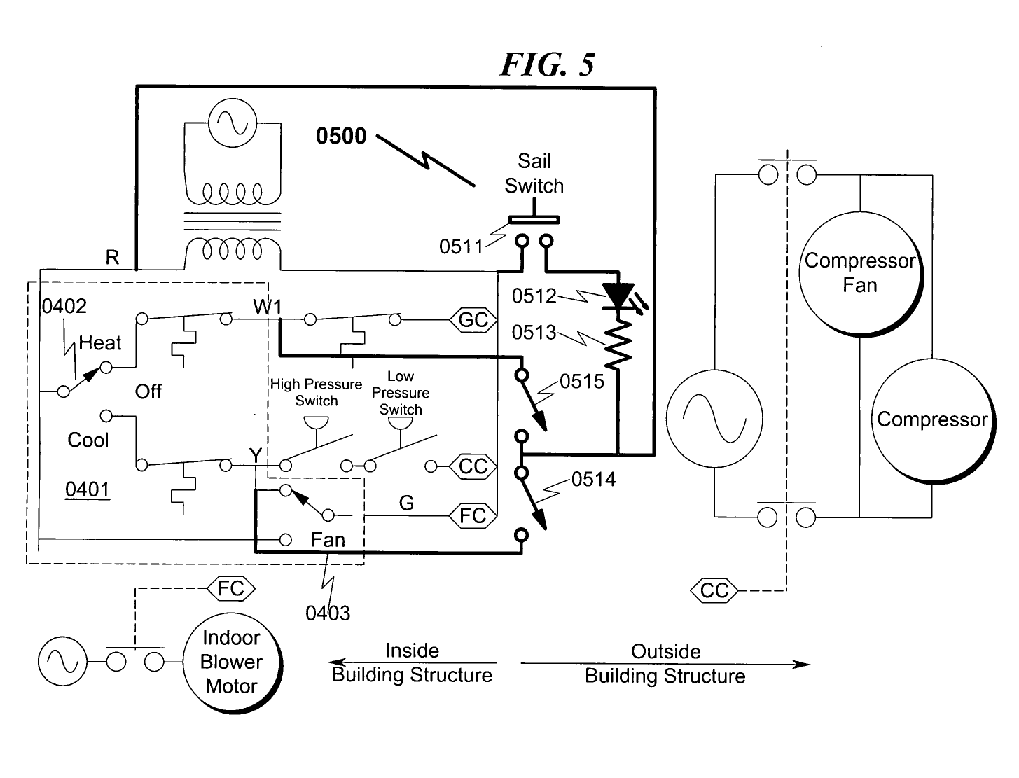

As generally illustrated in FIG. 5 (0500), the present invention generally incorporates one or more override switches (0514, 0515) to override the building thermostat and permit HVAC service personnel the ability of cycling the air conditioner and/or heating system without physical access to the thermostat inside the building. These override switches (0514, 0515) may be located within a service access panel within the air conditioner condenser/compressor unit located external to the customer building. This location permits access by HVAC service personnel without inadvertent activation by the customer.

The strength of the improvement as illustrated in FIG. 5 (0500) is that this simple improvement in system wiring can eliminate the need for customers to be present during routine HVAC servicing operations. Typically, during many service calls the refrigerant levels must be increased and refrigerant pressures tested under normal operating conditions. These conditions cannot be activated without overriding the thermostat settings. The present invention permits this operation with minimal system cost and system retrofit costs.

### Exemplary Wireless System Embodiment (0600)

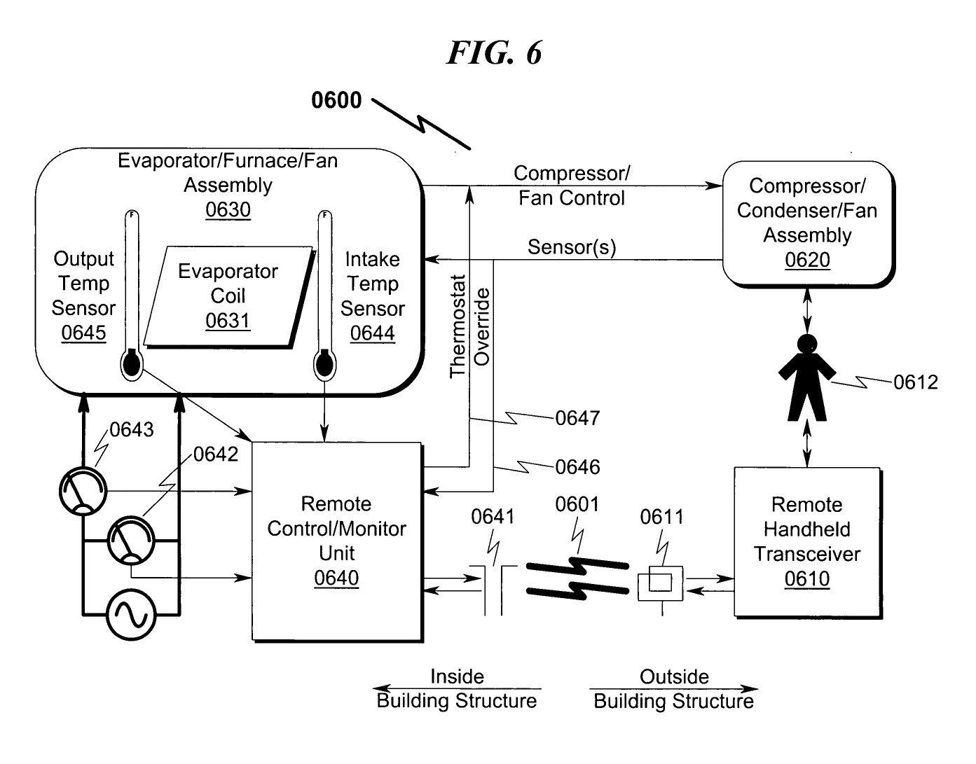

As generally illustrated in FIG. 6 (0600), the present invention may optionally incorporate wireless technology to permit remote monitoring and control of a HVAC system from outside the premises of a customer building structure. In this general wireless configuration, a remote handheld transceiver (0610) under operational control of a technician (0612) communicates with a remote control/monitor unit (0640) via antennas (0611, 0641) and a wireless communication link (0601).

The remote control/monitor unit (0640) takes as its input a variety of sensors associated with the evaporator/furnace/fan assembly (0630) and the compressor/condenser/fan assembly (0620). Some illustrative examples of these sensor inputs include voltage (0642) and current (0643) monitors of the HVAC system as well as intake air temperature (0644) and output air temperature (0645) across the evaporator coil (0631) contained within the evaporator/furnace/fan assembly (0630). One skilled in the art will recognize that any sensor or switch associated with the operation of the HVAC system could be an input (0646) to the remote control/monitor unit (0640), and this list is not limited to the exemplary embodiment shown in FIG. 6.

Additionally, the remote control/monitor unit (0640) may operate to override the HVAC thermostat(s) located inside the customer building via the use of a variety of control interfaces (0647) associated with either the evaporator/furnace/fan assembly (0630) or the compressor/condenser/fan assembly (0620). One skilled in the art will recognize that any control or switch associated with the operation of the HVAC thermostatic control system could be an output (0647) from the remote control/monitor unit (0640), and this list is not limited to the exemplary embodiment shown in FIG. 6.

The preferred exemplary embodiment illustrated in FIG. 6 (0600) may be typically implemented with the remote control/monitor unit (0640) being attached to or located proximally to the evaporator/furnace/fan assembly (0630). Once the remote control/monitor unit (0640) is installed by the evaporator/furnace/fan assembly (0630), sensors (0642, 0643, 0644, 0645, 0646) may be attached as required and associated thermostatic control overrides attached (0647). Once this installation is complete, the HVAC system may be completely controlled from the remote handheld transceiver (0610) by the service technician (0612). This permits activation of the HVAC system and monitoring of its performance from outside the building premises, thus permitting a routine service call to be performed without the need for the presence or intervention of the customer.

To prevent unauthorized wireless access to the remote control monitor unit (0640), the remote control monitor unit (0640) may be equipped with an electronic serial number unique to this unit. One exemplary implementation of this feature might include the use of a model DS2411 Silicon Serial Number available from Dallas Semiconductor/MAXIM Corporation (Dallas Semiconductor Corp., 4401 South Beltwood Parkway, Dallas, Tex. 75244 USA, tel 972-371-4000, fax 972-371-3715, www.maxim-ic.com). One skilled in the art will recognize that there are a wide variety of methods available to achieve this functionality. The customer can provide this serial number to the service technician (0612) for entry into the remote handheld transceiver (0610) to permit authorized access to the monitoring and control functions available with the remote control/monitor unit (0640).

While a wide variety of methods are available to implant the temperature sensor functionality (0645, 0646) generally illustrated in FIG. 6, the Dallas Semiconductor (Dallas Semiconductor Corp., 4401 South Beltwood Parkway, Dallas, Tex. 75244 USA, tel 972-371-4000, fax 972-371-3715, www.maxim-ic.com) line of temperature sensors, such as the model DS1631, are preferred in many embodiments as these particular devices are inexpensive, easily installed, and easily interfaced to any microprocessor/microcontroller used to operate the remote control/monitor unit (0640).

While a wide variety of methods are available to implement the wireless transceiver communication functionality associated with the remote handheld transceiver (0610) and the remote control/monitor unit (0640), many preferred embodiments might include the use of QWIKRADIO® RF transceiver components available from MICREL Semiconductor (2180 Fortune Drive, San Jose, Calif. 95131 USA, tel (408) 944-0800, fax (408) 944-0970, www.micrel.com). These components may permit both a small form factor and low cost implementation of the features described in the invention teachings illustrated herein.

It is envisioned that many preferred embodiments of the present invention may be implemented using one or more microprocessors and/or microcontrollers. While a wide variety of microprocessors/microcontrollers are available that may be suitable for this purpose, PICMICRO® devices manufactured by MicroChip Technology Inc. (2355 West Chandler Blvd., Chandler, Ariz., USA 85224-6199, tel (480) 792-7200, www.microchip.com) may be preferred in many embodiments, as these devices may integrate sensors and other controls useful in implementing a given embodiment.

### Exemplary Wireless Thermostat System Embodiment (0700)

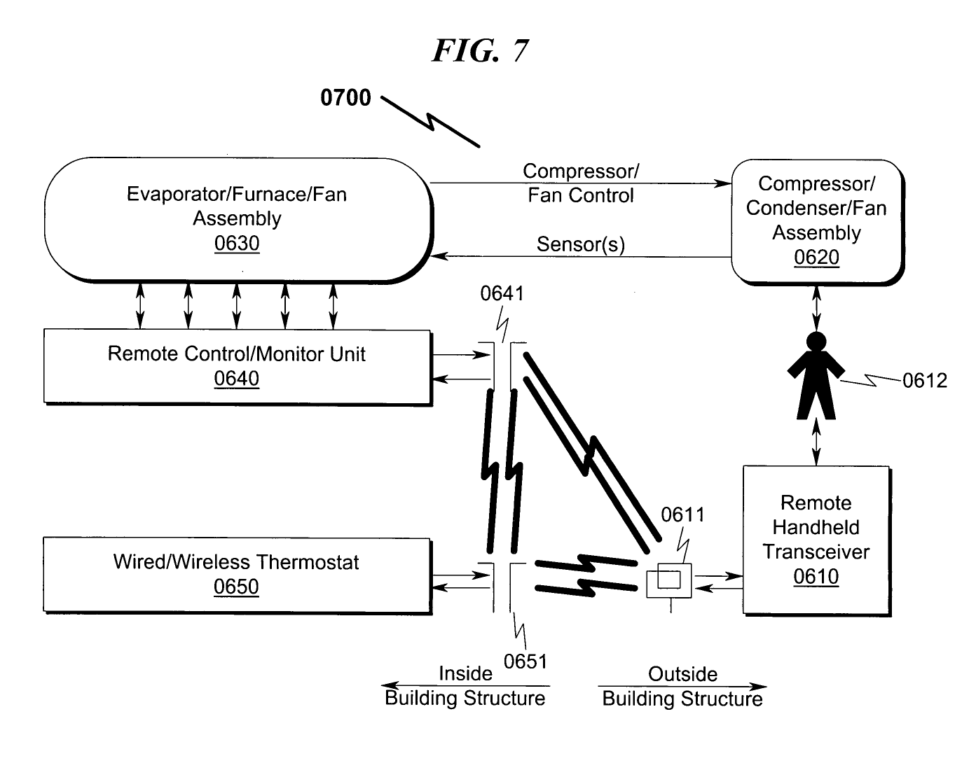

As generally illustrated in FIG. 7 (0700), the present invention may be implemented via the use of a wired or wireless thermostat (0650) replacement for an existing customer thermostat. In this configuration, the new thermostat (0650) can communicate (0651) with the remote control/monitor unit (0640) located at the evaporator/furnace/fan assembly (0630). As previously detailed in FIG. 6 (0600), the remote control/monitor unit (0640) may incorporate a variety of sensors and control interfaces to the evaporator/furnace/fan assembly (0630) and/or the compressor/condenser/fan assembly (0620).

The configuration in FIG. 7 (0700) permits a variety of improvements over the prior art. Firstly, there need be no physical wiring connecting the thermostat (0650) and the HVAC system, permitting the thermostat (0650) to be located anywhere within a given customer structure. This is especially important in retrofit situations where the thermostat must be placed in a new location other than that of the original thermostat. In many circumstances a redesigned HVAC system incorporates new thermostat placement, which is difficult when using existing wired thermostat systems. The present invention corrects this deficiency in the prior art.

Secondly, the present invention as illustrated in FIG. 7 (0700) permits multiple thermostats to be located within the customer building structure, all of which may have access to and control the HVAC system. These individual thermostats may also be used to communicate with HVAC damper systems to permit airflows in a given building room to be individually controlled.

Thirdly, the system as illustrated in FIG. 7 (0700) permits information within a given thermostat to be accessed by the service technician (0612) via the remote handheld transceiver unit (0610). Access to the thermostat (0650) by the remote handheld transceiver unit (0610) permits the service technician to retrieve logs maintained by the thermostat indicating the actual in-service time of the HVAC system, as well as ambient temperature logs and air intake/output temperature histories. This information can be vital to the service technician (0612) in troubleshooting problems such as clogged evaporator coils, frozen/seized fan motors, dirty air filters, and other problems typically associated with poor HVAC system performance.

The configuration illustrated in FIG. 7 (0700) is the most flexible of the systems illustrated, as it provides the ability to retrofit an existing HVAC system with full monitoring and control functionality which can be performed remotely to the customer building. Service calls can be completed in many circumstances without the need for customer intervention, and the ability to monitor HVAC system parameters such as input/output evaporator coil temperatures, HVAC system input voltages and current consumption, permit the service technician the widest information base on which to both diagnose and correct HVAC system failures. The ability to perform this monitoring functionality remotely also permits maintenance functions to be performed on a more routine basis, thus increasing the efficiency and conserving energy used by the HVAC system. Given that any HVAC system within a typical home consumes 25%-50% of the energy used by the building structure, any increase in system efficiency when multiplied by the number of homes which might use this invention would result in substantial energy savings when used extensively throughout the country.

### System Variations

The present invention anticipates a wide variety of variations in the basic theme of construction. The examples presented previously do not represent the entire scope of possible usages. They are meant to cite a few of the almost limitless possibilities.

### HVAC Diagnostic Method (0800)

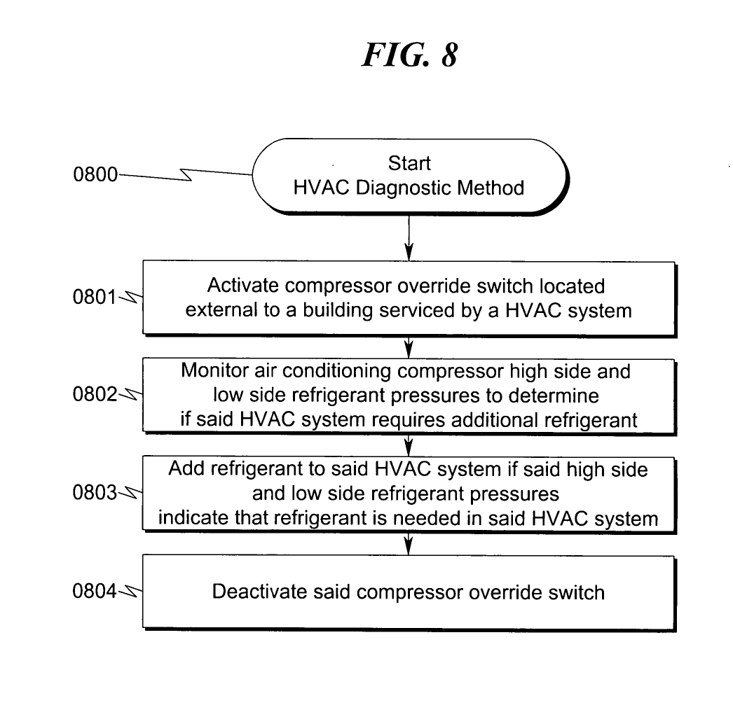

The present invention teaches a generalized HVAC diagnostic method which is generally illustrated in FIG. 8 (0800) and includes the following steps:
1. activation of a compressor override switch located external to a building serviced by a HVAC system (0801);
2. monitoring of air conditioning compressor high side and low side refrigerant pressures to determine if the HVAC system requires additional refrigerant (0802);
3. adding refrigerant to the HVAC system if the high side and low side refrigerant pressures indicate that refrigerant is needed in the HVAC system (0803);
4. deactivating the compressor override switch (0804);

One skilled in the art will recognize that these steps may in some circumstances be rearranged with no loss of function with respect to application in the field of HVAC diagnostic techniques.

### Energy Conservation

The present invention permits a significant conservation in energy associated with residential HVAC systems by permitting more frequent and thorough HVAC system servicing than is currently possible in the art.

The U.S. Department of Energy in their report on ENERGY EFFICIENCY AND RENEWABLE ENERGY, Technology Fact Sheet/Improved HVAC systems has stated that
“Heating, ventilation and air conditioning (HVAC) systems account for 40% to 60% of the energy used in U.S. commercial and residential buildings. Proven technologies and design concepts, along with energy efficient HVAC technologies will allow these services to be provided with significant energy savings and lower lifecycle costs.
HVAC systems also have a significant effect on the health, comfort, and productivity of occupants.

Issues including user discomfort, improper ventilation, and poor indoor air quality are linked to HVAC system design and operation and can be corrected by improved mechanical and ventilation systems. As with lighting systems, the productivity gains from a well designed and implemented HVAC system can result in savings that are many times the energy savings alone.
Optimizing the design and benefits requires that your mechanical system designer and your architect address major issues early in the schematic design phase and work closely together throughout the design process. It is also essential that you implement well-thought-out commissioning processes and routine preventative maintenance programs.”

In this context, “HVAC maintenance” is defined by the U.S. Department of Energy
“An HVAC conservation feature consisting of a program of routine inspection and service for heating and/or cooling equipment. The inspection is performed on a regular basis, even if there are no apparent problems.” (Source: U.S. Department of Energy EIA (Energy Information Administration). (U.S. Department of Energy, ENERGY EFFICIENCY AND RENEWABLE ENERGY, Technology Fact Sheet/Improved HVAC systems)

Thus, even small improvements in energy conservation associated with proper maintenance of residential and commercial HVAC systems can result in drastic energy conservation measures being realized on a nationwide basis. Much of the current routine maintenance is performed when HVAC system components rather than on a preventative basis. A primary reason for this delay in applying proper maintenance principles is the fact that it is not possible for the HVAC service technician to access the HVAC system controls without the on-site presence of the homeowner. The present invention eliminates this requirement and thus permits a higher level of system maintenance, reducing overall system energy consumption by increasing HVAC system efficiencies.

### CONCLUSION

A HVAC diagnostic system and method has been disclosed which incorporates a system and method for bypassing the normal operation of a thermostat or other control by HVAC service personnel when located outside a building or structure, typically permitting the HVAC service personnel control over thermostat functionality while servicing the condenser coils and/or compressor located external to customer building.

The present invention is extremely useful in situations where HVAC service calls must be scheduled at customer premises such as homes, apartments, etc., during normal business hours where the occupants are not typically available to permit access to the control thermostat within the building structure. By permitting override of the customer thermostat at the compressor/condenser unit, the present invention permits servicing of this unit without any assistance of the customer. As such, HVAC service can be completed on a more regular schedule, saving energy and providing improved customer environmental comfort. The present invention discloses a variety of preferred embodiments, including external wired thermostat overrides as well as fully wireless embodiments that incorporate additional environmental monitoring capabilities.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A HVAC diagnostic system comprising:
(a) sail switch;
(b) light emitting diode (LED);
(c) current limiting resistor;
(d) compressor override switch;
(e) heating override switch;
wherein
said sail switch, said light emitting diode, and said current limiting resistor are connected in series to a source of electric power wherein said sail switch makes contact and illuminates said LED when air flow is detected within a building serviced by a HVAC system;
said compressor override switch is located outside said building and permits activation of the air conditioning compressor in said HVAC system;
said heating override switch is located outside said building and permits activation of the furnace or heating unit is said HVAC system;
said override switches permit service of said HVAC system without entry into said building.

2. The HVAC diagnostic system of claim 1 wherein said LED, said compressor override switch, and said heating override switch are located is located outside of said building proximal to the enclosure housing the compressor and compressor fan of said HVAC system.

3. A wireless HVAC diagnostic system comprising:
(a) remote handheld transceiver;
(b) remote control/monitor unit;
(c) HVAC sensor inputs from a HVAC system; and
(d) HVAC control outputs to said HVAC system;
wherein
said remote handheld transceiver communicates via a wireless communication link to said remote control/monitor unit;
sail remote control/monitor unit is electrically connected to said HVAC sensor inputs and said HVAC control outputs, reading said HVAC sensor inputs and activating said HVAC control outputs in response to commands sent wirelessly via said remote handheld transceiver.

4. The wireless HVAC diagnostic system of claim 3 further comprising a wireless thermostat that communicates with said remote control/monitor unit and said remote handheld transceiver.

5. The wireless HVAC diagnostic system of claim 3 wherein said HVAC sensor inputs further comprise an evaporator/furnace/fan assembly intake temperature sensor.

6. The wireless HVAC diagnostic system of claim 3 wherein said HVAC sensor inputs further comprise an evaporator/furnace/fan assembly output temperature sensor.

7. The wireless HVAC diagnostic system of claim 3 wherein said HVAC sensor inputs further comprise a voltage sensor connected to the power input to the evaporator/furnace/fan assembly of said HVAC system.

8. The wireless HVAC diagnostic system of claim 3 wherein said HVAC sensor inputs further comprise a current sensor connected to the power input to the evaporator/furnace/fan assembly of said HVAC system.

9. The wireless HVAC diagnostic system of claim 3 wherein said HVAC control outputs override the thermostat controlling said HVAC system.

10. A HVAC diagnostic method comprising:
(1) activation of a compressor override switch located external to a building serviced by a HVAC system;
(2) monitoring of air conditioning compressor high side and low side refrigerant pressures to determine if said HVAC system requires additional refrigerant;
(3) adding refrigerant to said HVAC system if said high side and low side refrigerant pressures indicate that refrigerant is needed in said HVAC system;
(4) deactivating said compressor override switch.
